(19) United States
(12) Patent Application Publication
(10) Pub. No.: US 2007/0192516 A1
(43) Pub. Date: Aug. 16, 2007

(54) Virtual FIFO automatic data transfer mechanism

(75) Inventors: Sharif M. Ibrahim, Smithtown, NY (US); William J. Mahany, West Islip, NY (US); Larisa Troyegubova, Nesconset, NY (US); Bishnu B. Karki, Centereach, NY (US); Kenneth G. Smalley, Hauppauge, NY (US)

Correspondence Address: MEYERTONS, HOOD, KIVLIN, KOWERT & GOETZEL, P.C., P.O. BOX 398, AUSTIN, TX, 78767-0398, US

(73) Assignee: Standard Microsystems Corporation

(21) Appl. No.: 11/355,677

(22) Filed: Feb. 16, 2006

(51) Int. Cl. G06F 13/28

(52) U.S. Cl. 710/22

(57) ABSTRACT

A virtual FIFO automatic data transfer mechanism. A processor unit may allocate memory space within system memory for a data transfer operation. The processing unit may also program both a source device and a target device to perform the data transfer operation. After the programming, the source and target devices perform the data transfer operation without intervention by the processing unit until completion. The source device may store data into the allocated memory space, and indicate to the target device when it has stored a predetermined number of data bytes into the allocated memory space. In response to receiving the notification message, the target device may read the stored data from the allocated memory space, and indicate to the source device when the target device has read a predetermined number of data bytes from the allocated memory space.

### BACKGROUND OF THE INVENTION

1. Field of the Invention

This invention relates to data transfer methodologies and, more particularly, to a method and apparatus for automatically transferring data between devices using a virtual FIFO mechanism.

2. Description of the Related Art

Computer systems implement a variety of techniques to perform data transfer operations between devices. Typically, data transfer techniques require processor intervention throughout the data transfer operation, and may need detection of a data transfer before configuring a channel. Furthermore, the devices that perform the data transfer operation usually include fixed multi-packet data buffers.

When a data transfer mechanism requires processor intervention throughout the data transfer operation, the performance of the system may suffer. In various techniques, the processing unit typically has to allocate fixed memory buffers to the corresponding channel, configure a source device to write to the fixed memory buffers, and wait until the write operation is completed. After the source device completes the write operation, the processor usually has to configure the target device to read the data from the fixed memory buffer. In these techniques, the processor may be involved in every step of the transaction and therefore the system may continuously sacrifice valuable processing power. In addition, constant processor intervention may greatly complicate software development for the system.

One drawback to requiring detection of a data transfer before configuring a channel is that a detected data transfer typically has to be discarded since the channel is not yet configured to perform the data transfer operation. After the channel is subsequently programmed, the system may then have to wait for the source device to perform that particular data transfer once again. In some cases, the source device may not perform the data transfer a second time, and even if it does, the time spent waiting adds latency to the system.

Devices that perform data transfer operations may include one or more fixed size buffers. The inherent size limitations of fixed size buffers typically force some protocols to limit their packet size, which may reduce the throughput, e.g., SPI may be limited to 512 byte packets. In addition, fixed size buffers may not be feasible for some protocols, e.g., Ethernet that has streaming data. In systems with various devices, the system may include a multitude of these fixed size buffers. Architectures with various fixed size buffers may waste considerable amounts of space and power.

Furthermore, systems that perform data transfer operations typically transfer data from a source device directly to memory on a target device. This communication requirement usually results in a significant number of interfaces between devices and leads to routing congestion.

### SUMMARY OF THE INVENTION

Various embodiments are disclosed of a virtual FIFO automatic data transfer mechanism. In one embodiment, a computer system includes a bus, at least one source device and one target device, a system memory, and a processing unit. The processor unit allocates memory space within the system memory for a data transfer operation. The processing unit also programs both the source device and the target device to perform the data transfer operation. After the programming, the source and target devices perform the data transfer operation without intervention by the processing unit until completion.

In one embodiment, during the programming, the processing unit may define the size of the data transfer operation, define the memory address corresponding to the beginning of the allocated memory space and the memory address corresponding to the end of the allocated memory space, and define a source packet size for the source device and a target packet size for the target device. During operation, the source device may store data into the allocated memory space. The source device may then send a notification message to the target device to indicate when the source device has stored a predetermined number of data bytes (e.g., source packet size) into the allocated memory space. In response to receiving the notification message, the target device may read the stored data from the allocated memory space. After performing the read operation, the target device may send a notification message to the source device to indicate when the target device has read a predetermined number of data bytes (e.g., target packet size) from the allocated memory space.

During the data transfer operation, when the end of the allocated memory space is reached during a write operation, a source memory pointer may be updated to point to the beginning of the allocated memory space. Additionally, when the end of the allocated memory space is reached during a read operation, a target memory pointer may be updated to point to the beginning of the allocated memory space.

In one embodiment, the system may include a plurality of devices, each including a plurality of endpoints. During the programming, the processing unit may program at least a subset of the endpoints from at least one of the devices to perform data transfer operations. In this embodiment, the processing unit may allocate a separate memory space within the system memory for each of the data transfer operations.

In one embodiment, the computer system may perform data transfer operations without transferring data directly from the source device to the target device. Furthermore, the source and target devices may perform a data transfer operation using the allocated memory space within the system memory and without using fixed size buffers.

### BRIEF DESCRIPTION OF THE DRAWINGS

FIG. 1 is a block diagram of one embodiment of a system including a virtual FIFO automatic data transfer mechanism;

FIG. 2 is a diagram of one specific implementation of the virtual FIFO automatic data transfer mechanism, according to one embodiment;

FIG. 3 is a flow diagram illustrating a method for performing a data transfer operation using the virtual FIFO automatic data transfer mechanism, according to one embodiment; and

FIG. 4 is a flow diagram illustrating one specific implementation of the method for performing a data transfer operation using a virtual FIFO automatic data transfer mechanism, according to one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION

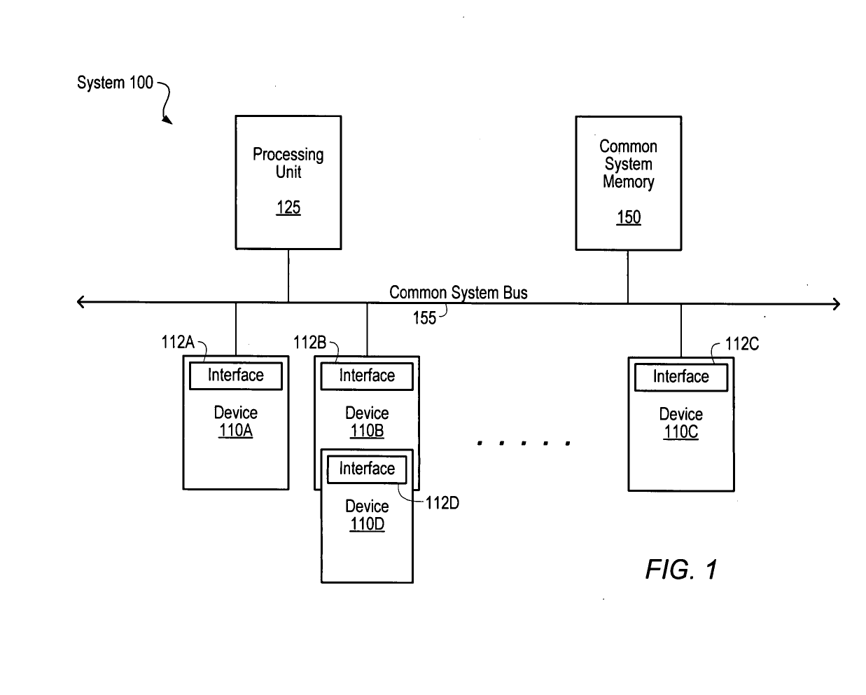

FIG. 1 is a block diagram of one embodiment of a system 100 including a virtual FIFO automatic data transfer mechanism. In one specific implementation, system 100 is formed as illustrated in the embodiment of FIG. 1. System 100 may include a processing unit 125 connected to a common system memory 150 via a common system bus 155. Additionally, system 100 includes one or more data communication devices 110 connected to processing unit 125 and common system memory 150 through the common system bus 155. Each device 110 may include a programmable data transfer interface 112. In the illustrated embodiment of FIG. 1, system 100 includes devices 110A-C and portable device 110D, which include the corresponding programmable data transfer interfaces 112A-D. It is noted, however, that in other embodiments system 100 may include any number of devices 110.

System 100 may be any of various types of computing or processing systems, including a personal computer system (PC), mainframe computer system, workstation, server blade, network appliance, system-on-a-chip (SoC), Internet appliance, personal digital assistant (PDA), television system, audio systems, grid computing system, or other device or combinations of devices, which in some instances form a network. In general, the term “computer system” can be broadly defined to encompass any device (or combination of devices) having at least one processor that executes instructions from a memory medium.

The virtual FIFO automatic data transfer mechanism may be implemented in any system that requires a data transfer interface between devices (e.g., devices 110). The devices may transfer data in any form, such as streaming data or packetized data. For example, in various embodiments, the virtual FIFO automatic data transfer mechanism may be implemented at least in flash media device applications, for example, USB to various types of flash media interfaces. This data transfer mechanism may also be used in back-end devices, such as card readers and ATA drives.

It is noted that virtual FIFO automatic data transfer mechanism may be implemented using hardware and/or software. It should also be noted that the components described with reference to FIG. 1 are meant to be exemplary only, and are not intended to limit the invention to any specific set of components or configurations. For example, in various embodiments, one or more of the components described may be omitted, combined, modified, or additional components included, as desired.

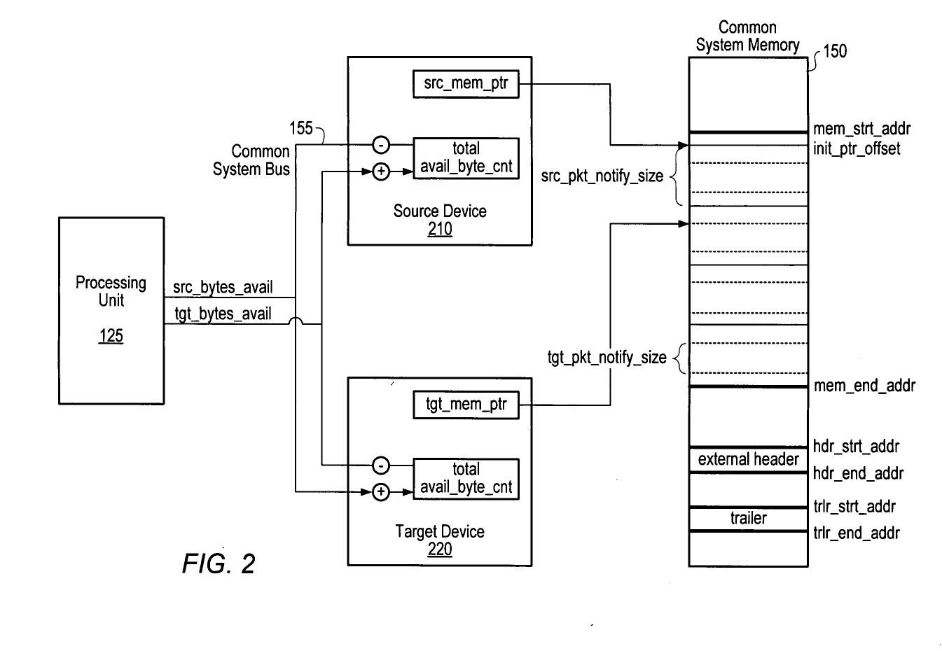

FIG. 2 is a diagram of one specific implementation of the virtual FIFO automatic data transfer mechanism, according to one embodiment. Source device 210 and target device 220 may represent two of the devices 110 of FIG. 1. In general, as depicted in the embodiment of FIG. 2, processing unit 125 may initially program the data transfer interface (e.g., 112) of source device 210 and target device 220 to perform a data transfer operation. In one embodiment, a data transfer interface may be control registers and other hardware and/or software within each device used for implementing the virtual FIFO automatic data transfer mechanism, for example.

In some cases, source device 210 may notify processing unit 125 of a pending data transfer operation. In other cases, processing unit 125 may detect a pending data transfer operation. It is noted, however, that processing unit 125 may find out about a pending or expected data transfer operation by other methods.

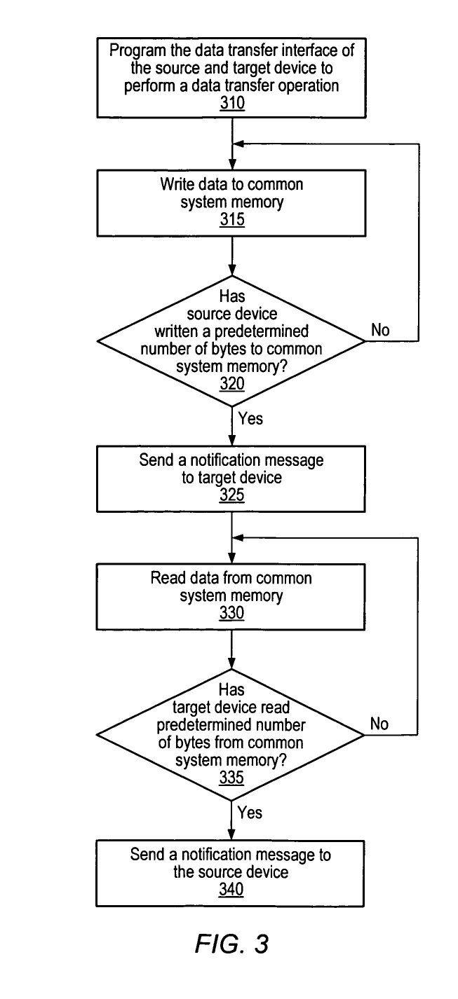

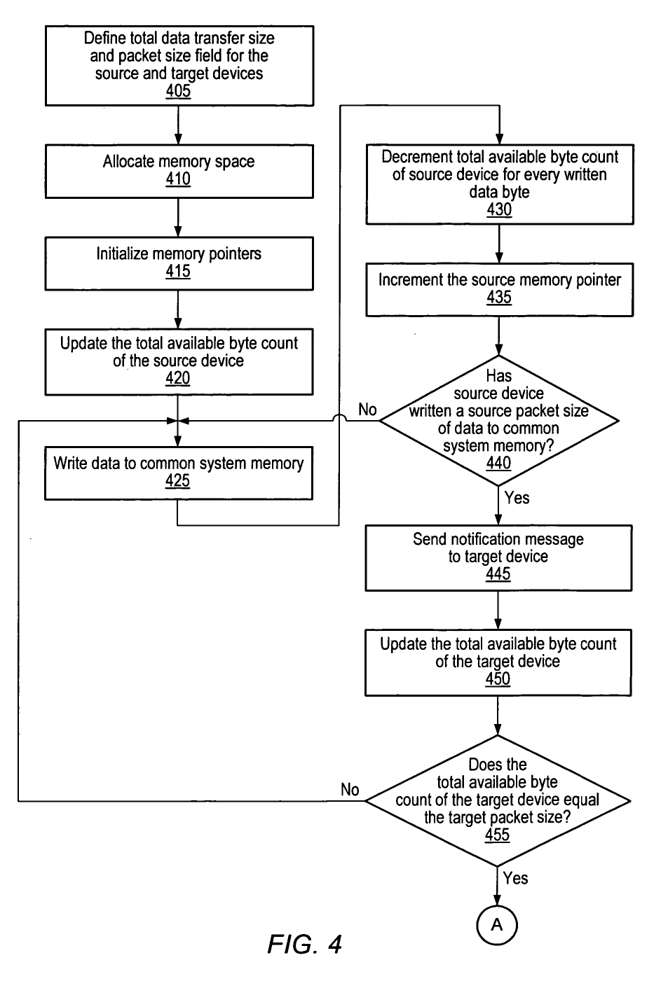

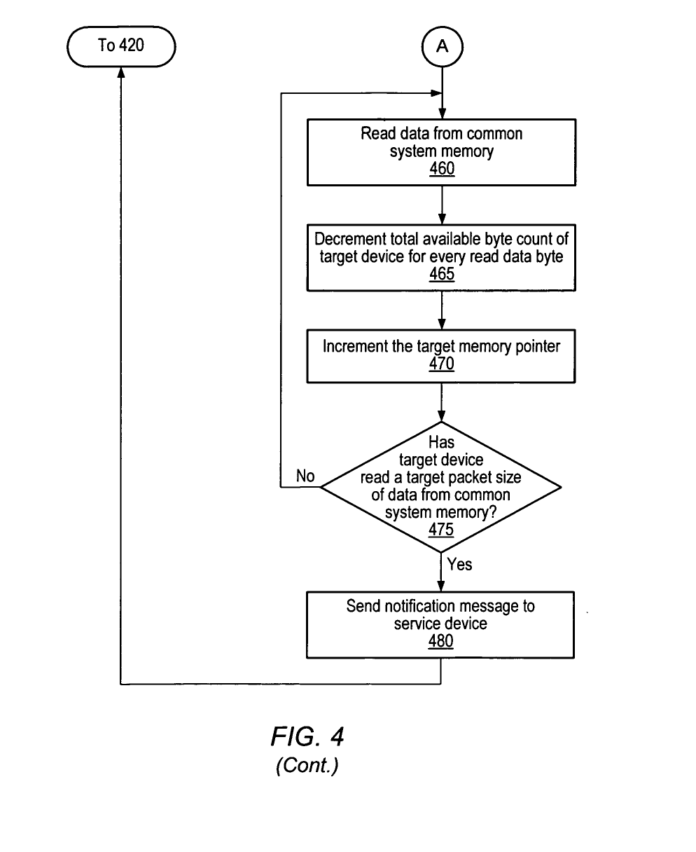

After the initial programming, source device 210 and target device 220 autonomously perform the data transfer operation using common system memory 150 and without intervention by processing unit 125 until completion, as will be described further below with reference to FIGS. 3 and 4.

FIG. 3 is a flow diagram illustrating a method for performing a data transfer operation using the virtual FIFO automatic data transfer mechanism, according to one embodiment. It should be noted that in various embodiments, some of the steps shown may be performed concurrently, in a different order than shown, or omitted. Additional steps may also be performed as desired.

Referring collectively to the embodiments illustrated in FIG. 2 and FIG. 3, during operation, processing unit 125 initially programs both source device 210 and target device 220 to perform the data transfer operation, as indicated in block 310. As will be described further below, during initial programming, processing unit 125 defines the size of the data transfer (tot_txfr_size), allocates enough memory space in the common system memory 150 to perform the data transfer operation, and defines the src_packet_notify_size for source device 210 and the tgt_packet_notify_size for target device 220, among others.

After initial programming, source device 210 and target device 220 autonomously perform the data transfer operation without intervention by processing unit 125 until completion. As indicated in block 315, source device 210 first performs a write operation to common system memory 150. Source device 210 then determines whether it has written at least a predetermined number of bytes into memory 150, as indicated in block 320. The predetermined number of bytes may be equal to the programmed src_packet_notify_size. If source device 210 has not written at least the predetermined number of bytes into memory 150, source device 210 performs another write operation to memory 150 (block 315). On the contrary, if source device 210 has written at least the predetermined number of bytes into memory 150, source device 210 sends a notification message to target device 220 (block 325). The notification message indicates the number of bytes (e.g., src_packet_notify_size) that source device 210 has written into memory 150.

As shown in block 330, after receiving the notification message from source device 210, target device 220 may read the stored data from common system memory 150. Target device 220 then determines whether it has read at least a predetermined number of bytes from memory 150, as indicated in block 335. The predetermined number of bytes may be equal to the programmed tgt_packet_notify_size. If target device 220 has not read at least the predetermined number of bytes from memory 150, target device 220 performs another read operation (block 330). On the other hand, if target device 220 has read at least the predetermined number of bytes, target device 220 sends a notification message to source device 210 (block 340). The notification message indicates the number of bytes (e.g., tgt_packet_notify_size) that target device 220 has read from memory 150. After receiving the notification message from target device 220, source device 210 may then reuse this particular memory space, e.g., to complete the current data transfer operation.

Specifically, as illustrated in the embodiment of FIG. 2, during initial programming, processing unit 125 may program the data transfer interface of source device 210 and target device 220 to define at least the following parameters associated with the data transfer operation: tot_txfr_size, pkt_notify_size, total_avail_byte_cnt, bytes_avail, mem_strt_addr, init_ptr_offset, and mem_end_addr.

The tot_txfr_size parameter may specify the size of the data transfer in bytes. If the tot_txfr_size parameter is set to zero, this may notify the applicable devices that the data transfer is continuous and may have no byte size limit. In most implementations, the programmed tot_txfr_size may be the same for both the source device and the target device.

The pkt_notify_size (or packet size) parameter may specify the number of bytes of data that a device may need to write/read to/from common system memory 150 before sending a notification message to the partner device indicating that the write/read operation has been performed. The src_pkt_notify_size (or the source packet size) for a source device may be the same or different than the tgt_pkt_notify_size (or the target packet size) for a target device. In some implementations, the pkt_notify_size may be defined based on the protocol used, for example, for USB 2.0 the pkt_notify_size may be 512 bytes and for USB 1.0 the pkt_notify_size may be 64 bytes. It is noted, however, that the pkt_notify_size may be defined as desired, as long as the pkt_notify_size is not programmed to be larger than a maximum transmission unit (MTU).

The total_avail_byte_cnt parameter may specify a running byte count of the available space in memory to write/read data to/from. Initially, the tot_avail_byte_cnt in both the source device and the target device may be set to zero. In some implementations, notification messages including a bytes_avail parameter, which may be sent from the processing unit, the source device, or the target device, may initialize or update the tot_avail_byte_cnt in at least one of the devices. The bytes_avail parameter may specify the number of bytes that can be written/read to/from memory.

The mem_strt_addr parameter may specify the starting address of the allocated memory region. The mem_end_addr parameter may specify the ending address of the allocated memory region.

The init_ptr_offset parameter may specify an offset address. The init_ptr_offset may reserve a predetermine amount of memory within the allocated memory space for a control information, e.g., a header. This offset parameter may inform a source device (e.g., 210) to write data in a memory location immediately after a header to prevent overwriting the header, and may provide a target device (e.g., 220) information to strip a local header, as will be described further below.

FIG. 4 is a flow diagram illustrating one specific implementation of the method for performing a data transfer operation using a virtual FIFO automatic data transfer mechanism, according to one embodiment. It should be noted that in various embodiments, some of the steps shown may be performed concurrently, in a different order than shown, or omitted. Additional steps may also be performed as desired.

Referring collectively to the embodiments of FIGS. 2-4, during operation, processing unit 125 initially programs the data transfer interface of source device 210 and target device 220 to perform the data transfer operation. During initial programming, as indicated by block 405, processing unit 125 defines the size of the data transfer (tot_txfr_size), and defines the src_packet_notify_size for source device 210 and the tgt_packet_notify_size for target device 220. Processing unit 125 also allocates enough memory space in the common system memory 150 to perform the data transfer operation, as indicated by block 410. The allocated memory space may be defined by the mem_strt_addr and mem_end_addr. In one embodiment, the size of the allocated memory space is approximately equal to three times the size of the largest packet_notify_size (either the src_packet_notify_size or the tgt_packet_notify_size). It is noted, however, that in other embodiments the size of the allocated memory space may be programmed with other values as desired.

Source device 210 and target device 220 may each implement a memory pointer (mem_ptr) to keep track of the location in memory where to perform a write or read operation. After receiving the information about the allocated memory space, source device 210 and target device 220 may initialize the memory pointers (src_mem_ptr and tgt_mem_ptr), as indicated by block 415. Assuming that the init_ptr_offset is zero, both memory pointers may initially point to the mem_strt_addr. As will be described further below, it is noted that in some cases the init_ptr_offset may be a value other than zero, e.g., to store a header.

During initial programming, processing unit 125 may send a notification message including a bytes_avail field to source device 210 to initialize the src_tot_avail_byte_cnt, as indicated by block 420. The notification message may program the src_tot_avail_byte_cnt to equal the number of available bytes indicated in the bytes_avail field. In one embodiment, the bytes_avail parameter included in the notification message sent to source device 210 may be equal to the size of the allocated memory space, i.e., the number of bytes associated with the allocated memory space. It is noted, however, that in other embodiments the src_tot_avail_byte_cnt may be programmed with other values as desired.

After initial programming, source device 210 and target device 220 autonomously perform the data transfer operation without intervention by processing unit 125 until completion. As indicated by block 425, source device 210 first performs a write operation to the allocated memory space within common system memory 150. Source device 210 may decrement the src_tot_avail_byte_cnt for every byte written to common system memory 150 (block 430), and may increment or update the src_mem_ptr to point to the next available memory location within the allocated memory space (block 435).

After each write operation, source device 210 determines whether it has written at least a predetermined number of bytes into common system memory 150, as indicated in block 440. The predetermined number of bytes may be equal to the src_packet_notify_size (source packet size). If source device 210 has not written at least the predetermined number of bytes into memory 150, source device 210 performs another write operation to memory 150 (block 425). On the contrary, if source device 210 has written at least the predetermined number of bytes into memory 150, source device 210 sends a notification message to target device 220 (block 445).

The notification message includes the bytes_avail field, which indicates the number of bytes that source device 210 has written into memory 150, e.g., the number of bytes corresponding to the src_packet_notify_size. Target device 220 takes the bytes_avail field from the notification message and initializes the tgt_tot_avail_byte_cnt, as indicated by block 450. It is noted that, when the tgt_tot_avail_byte_cnt is first initialized by the notification message from source device 210, the tgt_tot_avail_byte_cnt may be equal to the number of bytes corresponding to the src_packet_notify_size. It is noted, however, that in other embodiments the tgt_tot_avail_byte_cnt may be programmed with other values as desired.

As indicated by block 455, target device 220 then determines whether the tgt_tot_avail_byte_cnt equals a predetermined number of bytes, e.g., the number of bytes corresponding to the tgt_packet_notify_size (target packet size). If the tgt_tot_avail_byte_cnt does not equals the tgt_packet_notify_size, target device 220 may delay reading common system memory 150 until source device 210 has written at least the desired number of data bytes into memory 150 (block 425). If the tgt_tot_avail_byte_cnt equals the tgt_packet_notify_size, target device 220 may begin reading data from the allocated memory space within memory 150, as indicated by block 460. Target device 220 may decrement the tgt_tot_avail_byte_cnt for every data byte read from common system memory 150 (block 465), and may increment or update the tgt_mem_ptr to point to the next memory location within the allocated memory space (block 470).

In block 475, target device 220 determines whether it has read at least a predetermined number of bytes from the allocated memory space within common system memory 150. The predetermined number of bytes may be equal to the tgt_packet_notify_size (target packet size). If target device 220 has not read at least the predetermined number of bytes from memory 150, target device 220 performs another read operation (block 460). On the other hand, if target device 220 has read at least the predetermined number of data bytes, target device 220 sends a notification message to source device 210 (block 480). The bytes_avail field of the notification message indicates the number of data bytes (e.g., tgt_packet_notify_size) that target device 220 has read from memory 150. As indicated in block 485, source device 210 takes the bytes_avail filed from the notification message and updates the src_tot_avail_byte_cnt. By updating the src_tot_avail_byte_cnt, source device 210 is able to reuse this particular memory space in the future, e.g., to complete the current data transfer operation

In one embodiment, after updating the src_tot_avail_byte_cnt, source device 210 may determine whether the src_tot_avail_byte_cnt is greater than or equal to the src_packet_notify_size. Source device 210 may wait until src_tot_avail_byte_cnt is at least equal to the src_packet_notify_size before writing data to common system memory 150. This may ensure that there is enough memory available within the allocated memory space before performing a write operation.

When either the src_mem_ptr or the tgt_mem_ptr reaches the mem_end_addr, the device is configured loop back the mem_ptr around to the mem_strt_addr (assuming the initial offset is zero). As such, the allocated memory space (e.g., equal three times the largest pkt_notify_size) for the data transfer operation is utilized as a virtual FIFO, which may be versatile enough to handle most data transfers, including most continuous data streams.

The process illustrated in the embodiment of FIG. 4 may continue until the data transfer operation is completed, i.e., the number of data bytes indicated by the programmed tot_txfr_size have been transferred from source device 210 to target device 220. When the data transfer operation has been completed, both source device 210 and target device 220 may send a notification message to processing unit 125 indicating the status of the data transfer operation.

In some embodiments, at the end of the data transfer operation, source device 210 may send a notification message with the force_txfr field enabled to notify target device 220 that it has stored a short packet in common system memory 150. The force_txfr field may inform the receiving device that the data needs to be transferred regardless of restrictions that may be in place, for example, reading data only when source device 210 has written at least a predetermined number of data bytes (e.g., tgt_pkt_notify_size) to memory 150. In essence, the force_txfr filed may be used to indicate the end of the data transfer operation (although a trailer may still be appended if so programmed). It is noted, however, that in other embodiments the end of a data transfer operation may be indicated to target device 220 by other methods.

It is noted that the virtual FIFO automatic data transfer mechanism may be implemented by a variety of other methods. For example, in some embodiments, processing unit 125 may initially program the src_tot_avail_byte_cnt with the number of bytes corresponding to the src_packet_notify_size. When the src_tot_avail_byte_cnt counts down to zero, source device 210 may send a notification message to target device 220, and then update the src_tot_avail_byte_cnt with the number of bytes corresponding to the src_packet_notify_size. In this implementation, source device 210 may include a mechanism to determine whether there is enough available memory space in the allocated memory to perform a write operation.

In various embodiments, the data transfer operation may include transferring headers and/or trailers in addition to the actual data. The headers and/or trailers may be stored within or outside the allocated memory space of memory 150. During initial programming, processing unit 125 may program source device 210 and/or target device 220 with various parameters associated with headers and/or trailers, such as hdr_strt_addr, hdr_end_addr, trlr_strt_addr, and trlr_end_addr. During operation, the data transfer mechanism may automatically append or strip headers and trailers without intervention by processing unit 125.

When a header is directly written into the allocated memory space associated with the data transfer operation, processing unit 125 may program source device 210 with an init_ptr_offset to reserve enough memory space at the beginning of the allocated memory for the header. The init_ptr_offset also indicates the location in memory 150 where source device 210 may start writing data after the end of the header, i.e., the src_mem_ptr is initialized to point to the memory location associated with the init_ptr_offset.

During operation, target device 220 may need to read the header along with the actual data. In this case, processing unit 125 does not program target device 220 to offset its tgt_mem_ptr. However, in some cases, when target device 220 does not need to read the header, processing device 125 may program target device 220 with an offset, i.e., may define the tgt_init_ptr_offset, to strip the header. The tgt_mem_ptr may then point to the storage location associated with the tgt_init_ptr_offset, which allows target device 220 to ignore the header and read only the data. During the initial programming, processing unit 125 may also send a notification message to target device 220 indicating that a header exists and including the size of the header.

In some cases, the data transfer mechanism may need to append a header within common system memory 150 but outside the allocated memory space defined for the current data transfer. In these cases, processing unit 125 may program the data transfer interface of target device 220 by asserting the insert_ext_hdr bit and defining the hdr_strt_addr and hdr_end addr parameters. The insert_ext_hdr parameter indicates whether there are any headers outside the mem_strt and mem_end memory range, i.e., the allocated memory for the data transfer operation. The hdr_strt_addr and hdr_end_addr parameters indicate the memory location of the header.

Similarly, to append a trailer outside the allocated memory space, processing unit 125 may program the data transfer interface of target device 220 by asserting the insert_ext_trlr bit and defining the trlr_strt_addr and trlr_end_addr parameters. The insert_ext_trlr parameter indicates whether there are any trailers outside the allocated memory, and the trlr_strt_addr and trlr_end_addr parameters indicate the memory location of the trailer. During initial programming, processing unit 125 may also send a notification message to target device 220 indicating that a trailer exists and including the size of the trailer. It is noted, however, that in other embodiments headers and trailers may be appended or stripped during a data transfer operation by other methods.

As described above, the source and target devices may send notification messages to one another to indicate that data has been written to/read from common system memory 150. Each notification message may include a msg_context field, a bytes_avail field, and a force_txfr field. As was described above, the bytes_avail field informs the partner device how many data bytes were written/read to/from memory 150. The msg_context field informs the receiving device whether the data bytes are part of the header, the body, or the trailer, and identifies the sending device. The notification message may be generated only when the number of bytes transferred (written or read) is equal to the programmed pkt_notify_size, unless the number of bytes remaining in the data transfer operation is less than the pkt_notify_size, in which case a short packet may need to be transferred to complete the operation.

In various embodiments, the only required communication between source and target devices is included in the notification messages. This simple control communication mechanism and the use of the common system memory 150 may eliminate the need for dedicated point-to-point data paths between devices. This communication interface between devices may be performed solely over common system bus 155. In one embodiment, common system bus 155 may be an AMBA (Advanced Microprocessor Bus Architecture) bus. It is noted, however, that in other embodiments, common system bus 155 may be another type of common bus, e.g., a PCI bus.

Using common system memory 150 and common system bus 155 for all data transfers may minimize or eliminate the need for independent memories and fixed size buffers. Common system memory 150 may allow more effective utilization of resources since memory space for each data transfer operation may be dynamically allocated. Each allocated memory space within common system memory 150 may be used as a virtual FIFO to perform automatic data transfer operations. The tgt_mem_ptr implemented by target device 220 may point to the beginning of the virtual FIFO to read the most recently written data. The src_mem_ptr may point to the next available memory location in the allocated memory to store additional data. When the end of the allocated memory is reached, the process may loop back to the beginning of the allocated memory and thereby maintain the virtual FIFO characteristic. The size of the allocated memory is not restricted by the hardware implementation, thus there is no restriction on the size of the packets. Die size may also be reduced by eliminating dedicated fixed size buffers from the devices included in system 100.

Every device 110 in system 100 may include one or more endpoints. Each endpoint of the devices 110 may be configured as a unique control entity, which may be programmed independently by processing unit 125 to perform data transfer operations. The processes described above for implementing the virtual FIFO automatic transfer mechanism may be accomplished by initially programming one endpoint on source device 210 and one endpoint on target device 220. In addition, a multitude of data transfer operations may be performed by programming various endpoints of the devices 110.

Processing unit 125 may program one endpoint of a device (e.g., source device 210) to perform write operations, and another endpoint of the device to perform read operations. By programming one endpoint, the device may be configured to operate with a half-duplex channel, and by programming two endpoints, the device may be configured to operate with a full-duplex channel. Additionally, each device may be programmed to operate with one or more half-duplex and one or more full-duplex channels, as desired, to perform one or more data transfer operations. For example, a first device may need to perform three data transfer operation. Two of the operations may each require a full-duplex channel, and the other operation may require a half-duplex channel. In this example, processing unit 125 may program five different endpoints on the first device to implement one half-duplex and two full-duplex channels.

Since each endpoint on a device may be configured as a unique control entity, the ease of expandability of the system may be greatly improved. If a protocol is expanded to allow more endpoints or if the number of endpoints on a device is increased in the future, the virtual FIFO automatic transfer mechanism may be easily adapted by programming the desired number of endpoints. Since this data transfer mechanism uses a common system memory and a common system bus to perform data transfer operations, the addition of extra buffers or other hardware may not be necessary.

Processing unit 125 may allocate a specific region of common system memory 150 for each data channel. This may allow system 100 to perform complex tasks such as anticipating and prefetching the next data transfer operation. As such, multiple endpoints on multiple devices may be programmed prior to detection of an external data transfer operation on the channels. This may improve system performance because the channel may be already programmed when the data transfer is initiated, and therefore the devices may immediately accept the transferred data, instead of having to reject the data to configure the channel.

Furthermore, each endpoint may be independent of the other endpoints. This added flexibility may improve the performance of the system because multiple endpoints on a device may be programmed to perform multiple operations. Also, multiple endpoints on a variety of devices may be programmed to perform data transfer operations at the same time. The virtual FIFO automatic transfer mechanism provides a common software interface for programming every device that may be embedded within the system regardless of the functionality of the device. For example, devices including packet-based devices interfaces such as USB and Flash Media Cards, and streaming interfaces such as SPI and ATA.

Any of the embodiments described above may further include receiving, sending or storing instructions and/or data that implement the operations described above in conjunction with FIGS. 2-4 upon a computer readable medium. Generally speaking, a computer readable medium may include storage media or memory media such as magnetic or optical media, e.g. disk or CD-ROM, volatile or non-volatile media such as RAM (e.g. SDRAM, DDR SDRAM, RDRAM, SRAM, etc.), ROM, etc.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computer system comprising:
a bus;
at least one source device coupled to the bus;
at least one target device coupled to the bus;
a system memory coupled to the bus; and
a processing unit coupled to the bus, wherein the processing unit is configured to allocate memory space within the system memory for a data transfer operation;
wherein the processing unit is further configured to program both the source device and the target device to perform the data transfer operation using the allocated memory space;
wherein, after the programming, the source device is configured to store data into the allocated memory space and the target device is configured to read the stored data from the allocated memory space.

2. The computer system of claim 1, wherein, during the data transfer operation, the source device is further configured to indicate to the target device when the source device has stored a predetermined number of data bytes into the allocated memory space.

3. The computer system of claim 2, wherein, during the data transfer operation, the target device is further configured to indicate to the source device when the target device has read a predetermined number of data bytes from the allocated memory space.

4. The computer system of claim 1, wherein, during the programming, the processing unit is configured to:
define the size of the data transfer operation;
define the memory address corresponding to the beginning of the allocated memory space and the memory address corresponding to the end of the allocated memory space; and
define a source packet size for the source device and a target packet size for the target device.

5. The computer system of claim 4, wherein the source device is configured to implement a source memory pointer to perform write operations into the allocated memory space, wherein the source device is configured to store data into the allocated memory space starting with the memory location referenced by the source memory pointer and update the source memory pointer after storing the data, wherein the source device is further configured to indicate to the target device when the source device has stored a source packet size of data into the allocated memory space.

6. The computer system of claim 5, wherein the target device is configured to implement a target memory pointer to perform read operations from the allocated memory space, wherein the target device is configured to read the stored data from the allocated memory space starting with the memory location referenced by the target memory pointer and update the target memory pointer after reading the data, wherein the target device is further configured to indicate to the source device when the target device has read a target packet size of data from the allocated memory space.

7. The computer system of claim 6, wherein, during the data transfer operation, when the end of the allocated memory space is reached during a write operation, the source memory pointer is updated to point to the beginning of the allocated memory space, and when the end of the allocated memory space is reached during a read operation, the target memory pointer is updated to point to the beginning of the allocated memory space.

8. The computer system of claim 1, comprising a plurality of devices each including a plurality of endpoints, wherein, during programming, the processing unit is configured to program at least a subset of the endpoints from at least one of the devices to perform data transfer operations.

9. The computer system of claim 1, wherein the bus is configured to transmit control information between the source device and the target device, wherein the bus is also configured to transmit data between the source device and the system memory and between the target device and the system memory, wherein the computer system is configured to perform the data transfer operation without transferring data directly from the source device to the target device.

10. The computer system of claim 1, wherein the source and target devices are configured to perform the data transfer operation using the allocated memory space in the system memory and without using fixed size buffers.

11. The computer system of claim 1, wherein, after the programming, the source and target devices are configured to perform the data transfer operation without intervention by the processing unit until completion of the data transfer operation.

12. The computer system of claim 1, further comprising a plurality of devices, wherein the processing unit is configured to program at least a subset of the devices to perform a plurality of data transfer operations, wherein, during programming, the processing unit is configured to allocate a separate memory space in the system memory for each of the data transfer operations.

13. A method for performing data transfers in a computer system, the method comprising:
allocating memory space within a system memory for a data transfer operation;
programming both a source device and a target device to perform the data transfer operation using the allocated memory space;
after said programming, the source device storing data into the allocated memory space; and
the target device reading the stored data from the allocated memory space.

14. The method of claim 13, wherein said storing data into the allocated memory space further includes sending a notification message to the target device after storing a predetermined number of data bytes into the allocated memory space.

15. The method of claim 14, wherein said reading the stored data from the allocated memory space further includes sending a notification message to the source device after reading a predetermined number of data bytes from the allocated memory space.

16. The method of claim 13, wherein, said programming both a source device and a target device includes:
defining the size of the data transfer operation;
defining the memory address corresponding to the beginning of the allocated memory space and the memory address corresponding to the end of the allocated memory space; and
defining a source packet size for the source device and a target packet size for the target device.

17. The method of claim 16, wherein said storing data into the allocated memory space includes:
implementing a source memory pointer to perform write operations during the data transfer operation;
storing data into the allocated memory space starting with a memory location referenced by the source memory pointer;
updating the source memory pointer after storing the data; and
sending a notification message to the target device after storing a source packet size of data into the allocated memory space.

18. The method of claim 17, wherein said reading the stored data from the allocated memory space includes:
implementing a target memory pointer to perform read operations during the data transfer operation;
reading the stored data from the allocated memory space starting with a memory location referenced by the target memory pointer;
updating the target memory pointer after reading the stored data; and
sending a notification message to the source device after reading a target packet size of data from the allocated memory space.

19. The method of claim 18, wherein, if the end of the allocated memory space is reached during a write operation, updating the source memory pointer to point to the beginning of the allocated memory space, and if the end of the allocated memory space is reached during a read operation, updating the target memory pointer to point to the beginning of the allocated memory space.

20. A computer system comprising:
a bus;
a plurality of devices coupled to the bus;
a system memory coupled to the bus; and
a processing unit coupled to the bus, wherein the processing unit is configured to allocate a separate memory space within the system memory for each of a plurality of data transfer operations;
wherein the processing unit is further configured to program at least a subset of the devices to perform the plurality of data transfer operations using the allocated memory space, wherein for each data transfer operation the processing unit is configured to program a source device and a target device;
wherein, after the programming, for each data transfer operation the source device is configured to store data into the allocated memory space and the target device is configured to read the stored data from the allocated memory space.
